(19) United States
(12) Patent Application Publication
(10) Pub. No.: US 2015/0294149 A1
(43) Pub. Date: Oct. 15, 2015

(54) Multivariate Dynamic Biometrics System

(71) Applicant: ID-U BIOMETRICS LTD., Tirat Carmel (IL)

(72) Inventors: Daphna PALTI-WASSERMAN, Haifa (IL); Yoram WASSERMAN, Haifa (IL)

(73) Assignee: ID-U BIOMETRICS LTD., Tirat Carmel (IL)

(21) Appl. No.: 14/167,837

(22) Filed: Jan. 29, 2014

Related U.S. Application Data
(63) Continuation of application No. 11/792,318, filed on Jun. 5, 2007, now abandoned.

(30) Foreign Application Priority Data
Dec. 6, 2004 (IL) 165586

(51) Int. Cl. G06K 9/00; G06K 9/62

(52) U.S. Cl. CPC G06K 9/00617; G06K 9/00013; G06K 9/6201

(57) ABSTRACT

Methods and apparatuses for recognizing a subject (106), based on biometric features are provided. The recognition includes a ‘smart’ combination of the subject's behavioral (103), physical (102) and physiological characteristics.

This application is a continuation of U.S. Ser. No. 11/792,318, also entitled “Multivariate Dynamic Biometrics System”, filed on Jun. 5, 2007 as 371 of PCT/IL2005/001316, filed Dec. 5, 2005. The contents of these earlier applications are incorporated herein by reference, and the benefit therefrom is hereby claimed.

### BACKGROUND

The importance of securing computer systems, electronic transactions and gaining an access to highly protected, or restricted, facilities has been increasing over the years. Conventional password and cryptographic techniques seem well on their way to solving the security problems associated with computer systems, electronic commerce, electronic transactions, and so on. These techniques ensure that the set of digital identification keys associated with an individual person can be safely used in electronic transactions and information exchanges. Little, however, has been done to ensure that such identification keys can only be used by their legitimate owners. This is a critical link that needs to be addressed if computer access, electronic commerce, home banking, point of sale, electronic transactions, and similar mechanisms are to become truly secure.

The security field uses three different types of authentication:
Something you know—a password, PIN, or piece of personal information (such as your mother's maiden name);
Something you have—a card key, smart card, or token (like a Secure ID card); and/or
Something you are—biometrics.

Of these three approaches biometrics is considered the most secure and convenient authentication method. Thus as organizations search for more secure authentication methods for subject access, e-commerce, and other security applications, biometrics is gaining increasing attention.

Today, passwords handle most authentication and identification tasks. For example, most electronic transactions, such as logging into computer systems, getting money out of automatic teller machines (ATM), processing debit cards, electronic banking, and similar transactions require passwords. Passwords are an imperfect solution from several aspects. First as more and more systems attempt to become secure, a subject is required to memorize an ever-expanding list of passwords. Additionally, passwords are may be easily obtained by observing an individual when he or she is entering the password. Furthermore, there is no guarantee that subjects will not communicate passwords to others, lose passwords, or have them stolen. Thus, passwords are not considered sufficiently secure for many applications.

Biometrics measures, on the other hand, are considered more convenient and secure. Biometrics is based on an individual's unique physical or behavioral characteristics (something you are), which is used to recognize or authenticate his identity.

Common physical biometric applications examples includes: fingerprints, hand or palm geometry, retina scan, iris scan and facial characteristics. Various publications disclose using physical biometrics. For example, U.S. Pat. Nos. 6,119,096, 4,641,349 and 5,291,560 disclose iris-scanning methods. U.S. Pat. Nos. 6,018,739 and 6,317,544 disclose fingerprints methods. U.S. Pat. No. 5,787,187 discloses ear canal acoustics method. U.S. Pat. Nos. 6,072,894, 6,111,517 and 6,185,316 disclose face recognition method and U.S. Pat. No. 6,628,810 discloses hand-based authentication method.

Physical biometrics measures can be easily acquired, cannot be forgotten, and cannot be easily forged or faked. However, physical biometrics measures rely on external deterministic biological features, thus they can be copied by high precision reproduction methods, and be used for gaining unauthorized access to a secured system or to a restricted area. For example, a person may reproduce a fingerprint or an iris image of an authorized subject and use it as its own. Furthermore, an unauthorized subject may force, such as by threatening, an authorized subject to gain access to a secure system or place.

Typical behavioral characters include: signature, voice (which also has a physical component), keystroke pattern and gait. For example, U.S. Pat. No. 6,405,922 discloses using key stroke patterns as behavioral biometrics.

Behavioral biometrics, which is much harder to forge, potentially offers a better solution for authentication and identification applications. However behavioral biometrics characteristics are, in general, more difficult to generate, monitor, acquire and quantify. Thus, to this date, in spite of many technological developments and the growing needs for high security, biometric systems that use behavioral characteristics are still not widely in use. Less than 10% of the biometrics-based products available today are based on behavioral biometrics.

It is the intention of embodiments of this invention to provide a novel biometrics system, which incorporates behavior and physical biometrics features, thus providing a reliable, highly secure system at an affordable price tag.

### SUMMARY

There is thus provided, in accordance with some embodiments, systems and methods for recognizing a subject.

According to some embodiments, there is provided a system for recognizing a subject, the system may include a device adapted to provide at least one stimulus, wherein the stimulus is selected from a stimulus database including a multiplicity of stimuli, at least one sensor adapted to acquire at least one response of the subject to the stimulus and a controller adapted to select the stimulus from the database, to perform processing and analysis of the response, and to compare the result of the analysis to pre-stored subject-specific identification templates for recognizing the subject.

According to some embodiments, there is provided a system for recognizing a subject, the system may include a device adapted to provide at least one stimulus, at least one sensor adapted to acquire at least one response of a subject to the stimulus and a controller adapted to perform processing and analysis of stimulus-response pairs, and to compare the result of the analysis to pre-stored subject-specific identification templates for recognizing the subject.

According to some embodiments, there is provided a system for recognizing a subject, the system may include a device adapted to provide at least one stimulus, wherein the stimulus is selected from a stimulus database including a multiplicity of stimuli, at least one sensor adapted to acquire at least one response of the subject to the stimulus, and a controller adapted to select the stimulus from the database, to perform processing and analysis of stimulus-response pairs, and to compare the result of the analysis to pre-stored subject-specific identification templates for recognizing the subject.

According to some embodiments, there is provided a method for recognizing a subject, the method may include providing at least one stimulus, wherein the stimulus is selected from a stimulus database including a multiplicity of stimuli and processing and analyzing the response of the subject to the stimulus, wherein the result of the analysis is compared to pre-stored subject-specific identification templates for recognizing the subject.

According to some embodiments, there is provided a method for recognizing a subject, the method may include providing at least one stimulus, acquiring at least one response of the subject to the stimulus and processing and analyzing the stimulus-response pair, wherein the result of the analysis is compared to pre-stored subject-specific identification templates for recognizing the subject.

According to some embodiments, there is provided a method for recognizing a subject, the method may include providing at least one stimulus wherein the stimulus is selected from a stimulus database including a multiplicity of stimuli, acquiring at least one response of the subject to the stimulus, processing and analyzing the stimulus-response pair, wherein the result of the analysis is compared to pre-stored subject-specific identification templates for recognizing the subject.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate like elements.

### BRIEF DESCRIPTION OF THE DRAWINGS

Exemplary embodiments are illustrated in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 schematically illustrates a general layout of the system according to some embodiments of the disclosure;

FIG. 2a schematically illustrates the enrolment process according to some embodiments of the disclosure;

FIG. 2b schematically illustrates the authentication process according to some embodiments of the disclosure;

FIG. 3a schematically illustrates a first set-up (head mount) of the system according to some embodiments of the disclosure;

FIG. 3b schematically illustrates a second set-up (trackball) of the system according to some embodiments of the disclosure; and

FIG. 3c schematically illustrates a second set-up (semi-transparent display) of the system according to some embodiments of the disclosure;

FIG. 4 schematically illustrates some embodiment for analyzing the stimulus-response data (system modeling);

### DETAILED DESCRIPTION

A biometrics system and method for recognition tasks (authentication, and identification), is dependent on its abilities to uniquely characterize a subject. A subject can be characterized in many ways. Most biometrics systems, used today, are based on a single physical characteristic of the subject, such as fingerprint or iris scan. The disclosed invention suggests, according to some embodiments, selecting and utilizing a “smart” set of parameters (not one), which are used to characterize a subject and his state of mind. The selected parameters, when combined together, uniquely characterize a subject to any desired degree of confidence, and at the same time are very difficult to fake forge or fool. Most of the selected parameters characterize the subject to some extent (not necessarily uniquely), and at least some of the parameters depend on the subject's response to an evoked stimulus, thus falling into the scope of behavioral dynamic biometrics. In some embodiments, at least some of said selected stimuli evoke “automatic” (involuntary) responses from the subject. Such involuntary reactions, which cannot be controlled by the subject, or learned by others, provide extra security to said system and method. Thus a selection of a “good” set of stimuli in conjunction with a “smart” set of characterizing parameters enables the system to provide an ultra secure, high performance system and method for recognition tasks, which include identification, authentication, or determination of a state of mind of a subject.

To better understand how a smart set of parameters and a “good set of stimulus are selected, an explanation will be given hereinafter on how a subject may be biometrically characterized. A subject may be biometrically characterized by using permanent characteristics, such as an iris scan, skin tone, skin texture or fingerprint(s); physiological characteristics, such as body temperature and heart rate; and by behavioral characteristics, such as gait, signature and voice. Another option, to characterize a subject may include using dynamic behavioral characteristics, which involve a subject's response to a stimulus. Eye movements, body temperature, heart rate, and skin impedance, are examples of dynamic behavioral characteristics, which change in response to an external stimulus. U.S. Pat. No. 6,294,993, for example, discloses a system capable of detecting galvanic changes in the skin as a result of changes in a subject's state of mind Lang (“Looking at Pictures: Affective, Facial, Visceral, and Behavioral Reactions”, published in Psychophysiology, Vol. 30, pp. 261-273) showed in 1993 that skin conductance may change as a result of a person being aroused by an image. Lang's conclusion was that the higher the conductance, the lower the arousal or excitement, and vice versa. The amplitude of the skin conductance may also used to determine interest or attention.

Of the above biometrical characteristics mentioned, eye movement is the most complex parameter. It includes both voluntary and involuntary movements, and is the result of many factors among them: eye anatomy, eye physiology, type of stimulus, and subject's personality. The presented system and method take advantage of the complexity of the visual system, which provides many interesting characterizing parameters that can be used for “biometrically characterizing a subject.”

To understand how different eye movements can be used to characterize someone, a short review of the eye anatomy, physiology and functionality is given hereinafter. The retina of a human eye is not homogeneous. To allow for diurnal vision, the eye is divided into a large outer ring of highly light-sensitive but color-insensitive rods, and a comparatively small central region of lower light-sensitivity but color-sensitive cones, called the fovea. The outer ring provides peripheral vision, whereas all detailed observations of the surrounding world is made with the fovea, which must thus constantly be subjected to different parts of the viewed scene by successive fixations. Yarbus showed at 1967 (in “Eye movements during perception of complex objects, in L. A. Riggs, ed., and in “Eye Movements and Vision”, Plenum Press, New York, chapter VII, pp. 171-196) that the perception of a complex scene involves a complicated pattern of fixations, where the eye is held (fairly) still, and saccades, where the eye moves to foveate a new part of the scene. Saccades are the principal method for moving the eyes to a different part of the visual scene, and are sudden, rapid movements of the eyes. It takes about 100 ms to 300 ms to initiate a saccade, that is, from the time a stimulus is presented to the eye until the eye starts moving, and another 30 ms to 120 ms to complete the saccade. Usually, we are not conscious of this pattern; when perceiving a scene, the generation of this eye-gaze pattern is felt as an integral part of the perceiving process.

Fixation and saccades are not the only eye movement identified. Research literature, for example, “Eye tracking in advanced interface design, in W. Barfield & T. Furness, eds, ‘Advanced Interface Design and Virtual Environments’, Oxford University Press, Oxford, pp. 258-288”, by Jacob 1995, and “Visual Perception: physiology, psychology and ecology, 2nd edn, Lawrence Erlbaum Associates Ltd., Hove, UK”, by Bruce & Green 1990, identified six other different types of eye movements: (1) Convergence, a motion of both eyes relative to each other. This movement is normally the result of a moving stimulus: (2) Rolling is a rotational motion around an axis passing through the fovea-pupil axis. It is involuntary, and is influenced, among other things, by the angle of the neck; (3) Pursuit, a motion, which is a much smoother and slower than the saccade; it acts to keep a moving object foveated. It cannot be induced voluntarily, but requires a moving object in the visual field; (4) Nystagmus, is a pattern of eye movements that occur in response to the turning of the head (acceleration detected by the inner ear), or the viewing of a moving, repetitive pattern (the train window phenomenon). It consists of smooth ‘pursuit’ motion in one direction to follow a position in the scene, followed by a fast motion in the opposite direction to select a new position: (5) Drift and microsaccades, which are involuntary movements that occur during fixations, consist of slow drifts followed by very small saccades (microsaccades) that apparently have a drift-correcting function; and (6) Physiological nystagmus is a high-frequency oscillation of the eye (tremor) that serves to continuously shift the image on the retina, thus calling fresh retinal receptors into operation. Physiological nystagmus actually occurs during a fixation period, is involuntary and generally moves the eye less than 1°. Pupil size is another parameter, which is sometimes referred to as part of eye movement, since it is part of the vision process.

In addition to the six basic eye movements described above, more complex patterns involving eye movement have been recognized. These higher level and complex eye-movements display a clear connection between eye-movements and a person's personality and cognitive state. Many research studies concluded that humans are generally interested in what they are looking at; that is, at least when they do spontaneous or task-relevant looking. Exemplary publications include are “Perception and Information, Methuen, London, chapter 4: Information Acquisition, pp. 54-66” by Barber, P. J. & Legge, D. 1976; “An evaluation of an eye tracker as a device for computer input, in J. M. Carroll & P. P. Tanner, eds, ‘CHI+GI 1987 Conference Proceedings’, SIGCHI Bulletin, ACM, pp. 183-188. Special Issue”. by Ware & Mikaelian 1987); “The Human Interface: Where People and Computers Meet, Lifetime Learning Publications, Belmont, Calif., 94002”, by, Bolt 1984; and “The gaze selects informative details within pictures, Perception and Psychophysics 2, 547-552”, by Mackworth & Morandi 1967. Generally, the eyes are not attracted by the physical qualities of the items in the scene, but rather by how important the viewer would rate them. Thus during spontaneous or task-relevant looking, the direction of gaze is a good indication of what the observer is interested in (Barber & Legge (1976)). Similarly, the work done by Lang in 1993 indicates that, on average, the viewing time linearly correlates to the degree of the interest or attention an image elicits from an observer.

Furthermore, eye movements can also reflect the person's thought processes. Thus an observer's thoughts may be followed, to some extent, from records of his eye movements. For example it can easy be determined, from eye movement records, which elements attracted the observer's eye (and, consequently, his thought), in what order, and how often (Yarbus 1967, p. 190). Another example is a subject's “scan-path”. A scan-path is a pattern representing the course a subject's eyes take, when a scene is observed. The scan-path itself is a repeated in successive cycles. The subject's eyes stop and attend the most important parts of the scene, in his eyes, and skip the remaining part of the scene, creating a typical path. The image composition and the individual observer determine the scan-path, thus scan-paths are idiosyncratic (Barber & Legge 1976, p. 62).

The described eye movements and patterns, can be measured, acquired, and used as Biometrics characteristics of someone. Thus they are used as part of the Biometrics system and method detailed herein.

According to some embodiments, there is provided a system for recognizing a subject, the system may include a device adapted to provide at least one stimulus, wherein the stimulus is selected from a stimulus database including a multiplicity of stimuli, at least one sensor adapted to acquire at least one response of the subject to the stimulus and a controller adapted to select the stimulus from the database, to perform processing and analysis of the response, and to compare the result of the analysis to pre-stored subject-specific identification templates for recognizing the subject.

According to some embodiments, there is provided a system for recognizing a subject, the system may include a device adapted to provide at least one stimulus, at least one sensor adapted to acquire at least one response of a subject to the stimulus and a controller adapted to perform processing and analysis of stimulus-response pairs, and to compare the result of the analysis to pre-stored subject-specific identification templates for recognizing the subject.

According to some embodiments, there is provided a system for recognizing a subject, the system may include a device adapted to provide at least one stimulus, wherein the stimulus is selected from a stimulus database including a multiplicity of stimuli, at least one sensor adapted to acquire at least one response of the subject to the stimulus, and a controller adapted to select the stimulus from the database, to perform processing and analysis of stimulus-response pairs, and to compare the result of the analysis to pre-stored subject-specific identification templates for recognizing the subject.

In another embodiment, the identification templates may be stored in a personals smart card, a local database, a central database, a distributed database, or any combination thereof.

In another embodiment, the stimuli database is stored in a personals smart card, a local database, a PC, a central database, a distributed database, or any combination thereof.

According to some embodiments, there is provided a method for recognizing a subject, the method may include providing at least one stimulus, wherein the stimulus is selected from a stimulus database including a multiplicity of stimuli and processing and analyzing the response of the subject to the stimulus, wherein the result of the analysis is compared to pre-stored subject-specific identification templates for recognizing the subject.

According to some embodiments, there is provided a method for recognizing a subject, the method may include providing at least one stimulus, acquiring at least one response of the subject to the stimulus and processing and analyzing the stimulus-response pair, wherein the result of the analysis is compared to pre-stored subject-specific identification templates for recognizing the subject.

According to some embodiments, there is provided a method for recognizing a subject, the method may include providing at least one stimulus wherein the stimulus is selected from a stimulus database including a multiplicity of stimuli, acquiring at least one response of the subject to the stimulus, processing and analyzing the stimulus-response pair, wherein the result of the analysis is compared to pre-stored subject-specific identification templates for recognizing the subject.

According to some embodiments, the method may further include creating the multiplicity of stimuli, saving the stimuli into the database, and dividing the multiplicity of stimuli into sets, in a way that any selected stimuli set is adequate for recognizing the subject.

According to some embodiments, the method may further include periodically updating the stimuli database for improving the system's performance. According to some embodiments, the method may further include dynamically updating the identification templates of the subjects. According to some embodiments, the method may further include acquiring a physical, physiological or behavioral characteristic parameter from the subject.

According to some embodiments, recognizing a subject may include establishing the identity of the subject, authenticating the identity of the subject, determining psychological aspects of the subject or any combination thereof.

According to some embodiments, the psychological aspect of the subject may include state of mind, level of stress, anxiety, attentiveness, alertness, honesty or any combination thereof.

According to some embodiments, the stimulus may include at least one set of stimuli.

According to some embodiments, the stimulus may include at least one unpredicted stimulus.

According to some embodiments, the processing and analysis of the response may include processing and analysis of the time dependent behavior of the at least one response before, during and after the stimulus is generated.

According to some embodiments, the characteristic parameters may include heart rate, body temperature, iris scan, blinking, impedance, eye movement, finger print, skin texture, breathing pattern or any combination thereof.

According to some embodiments, the stimulus may include a visual stimulus. In another embodiment, the visual stimulus may include a static image, a dynamic image, a static pattern, a dynamic pattern, a moving target or any combination thereof. In another embodiment, the response may include eye movements, pupil size, pupil dynamic or any combination thereof. In another embodiment, the eye movements may include fixation, gaze, saccades, convergence, rolling, pursuit, nystagmus, drift and microsaccades, physiological nystagmus or any combination thereof. In another embodiment, the response is acquired and processed from left eye, right eye or any combination thereof.

In another embodiment, additional stimuli are selected from the stimuli database, until the system's performance reaches a predefined threshold.

In another embodiment, acquiring may further include monitoring the subject's performance to a selected task. In another embodiment, recognizing a subject may include validating that the subject is physically present and conscious.

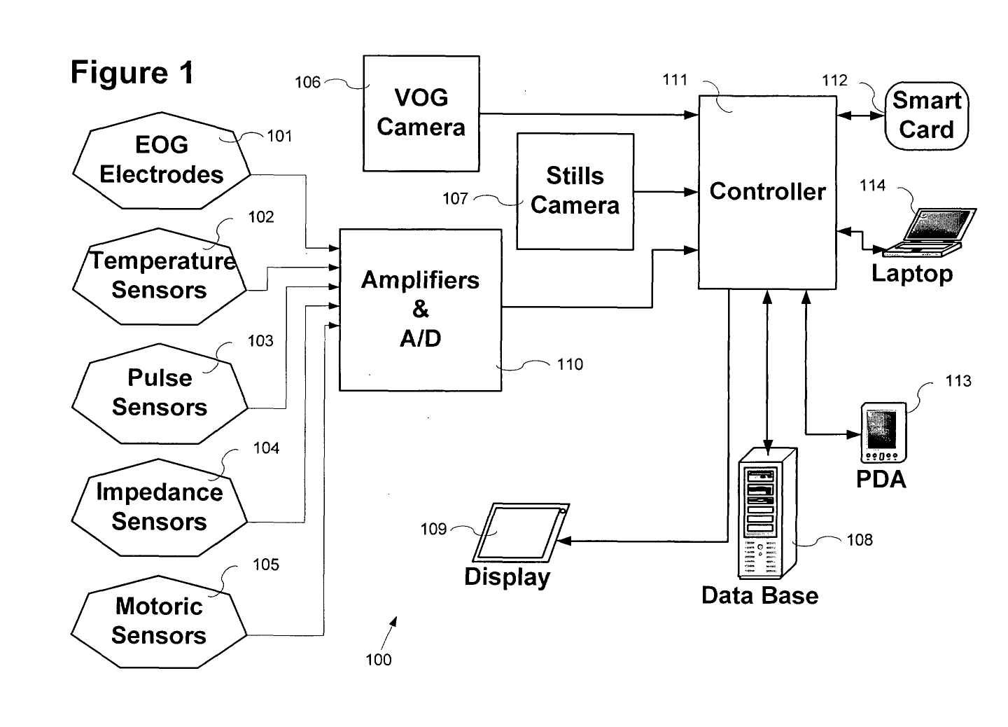

Referring now to FIG. 1, it schematically illustrates the general layout and functionality of the system, according to some embodiments of the present disclosure.

The system (100) disclosed herein, is generally designed to provide a visual stimulus to a subject, to acquire the subject's responses to the stimulus, to acquire additional parameters, to analyze the responses and to establish the subject's identification/authentication/state of mind (recognition), based on the analyzed response. More specifically, a series of biometric measurements are acquired from a subject by using a set of sensors (101 through 107). Next, a set of visual stimuli are selected from a database unit (108) and presented to a subject on a display panel (109). The subject's reactions to the stimuli, presented to him, are acquired by sensors (101 to 105), via an input unit (110) that includes amplifiers and Analog-to-Digital (“A/D”) converters, by a VOG (“Video Oculargraphy”) camera (106) and by a stills camera (107). The subject's responses, before, during and after the display of the stimuli, are used as input to a controller (111), which processes them. The processors results, and then compares against characteristic profiles, or biometric templates, of subjects, which were prepared in advance, in an enrollment stage, and stored in local or distributed Database 108. The database may take several different forms. For example, the database may be implemented as a personal “smart card” (112), a personal digital assistance (“PDA”, 113), a local database (laptop or PC, 114) or a remote network database (108), or any combination of the above. After the processing and comparison stages are completed, the system 100 can provide recognition of the subject.

### The Enrollment Process

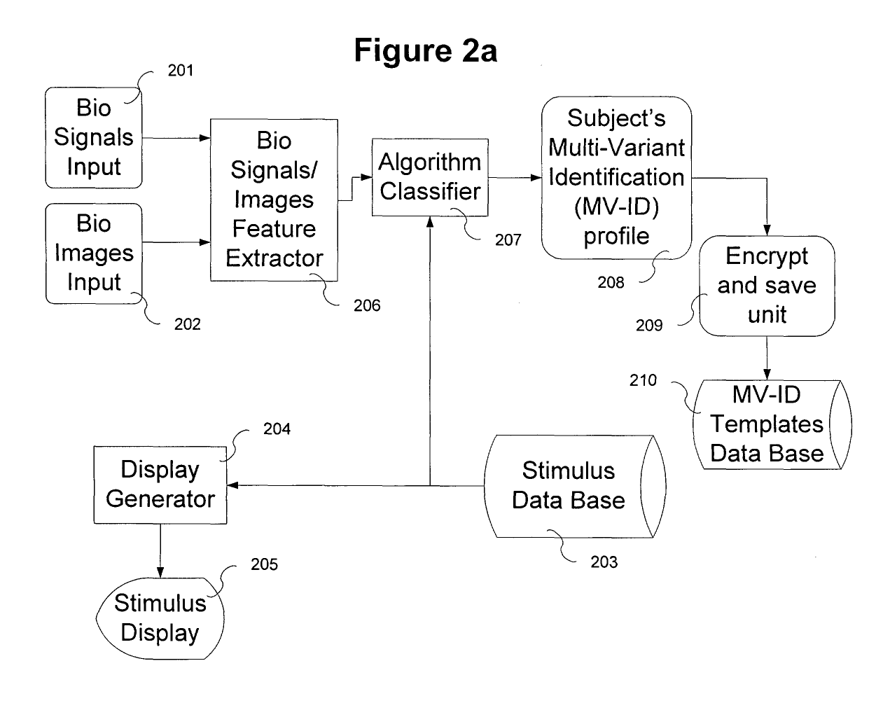

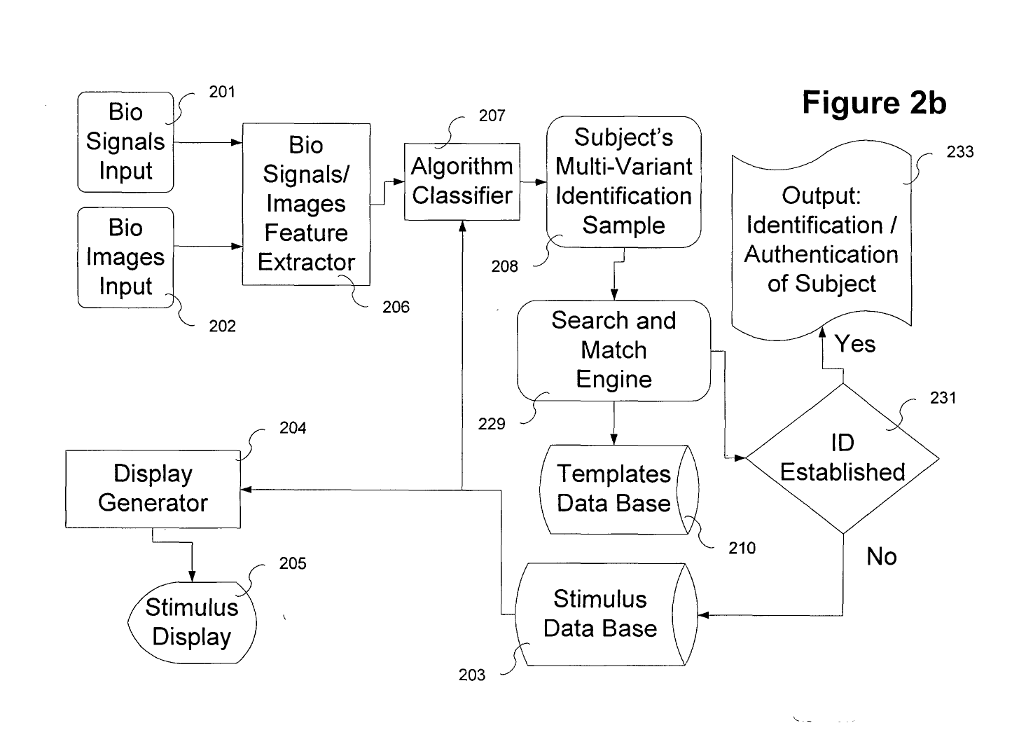

A biometric system such as system 100 of FIG. 1 requires an enrolment procedure before the recognition procedure can commence. The enrollment procedure, which is disclosed in FIG. 2a, is used to build or dynamically update a data base (210), which includes all potential subjects of the system and their unique biometric characteristics.

According to some embodiments, the enrollment process may include 3 stages:
a. Collection of dynamic behavioral characteristics of the subject;
b. Collection of static characteristics of the subject; and
c. Database formation and update.

At the first stage, the dynamic behavioral characteristics collection stage, a subject's responses (201, 202) to a set of different stimulus, which are selected from database unit 203, are acquired. In some applications, calibration steps may be required before the enrolment (or identification) of subjects begins. The set of stimuli are designed to evoke responses from the subject in a way that will help characterize the subject and emphasize differences between different subjects and their different states of mind. The subject's responses to the stimuli may include physiological and behavioral characteristics such as, but not limited to, body temperature, skin impedance, heart rate, breathing patterns and eye movements.

The acquired responses are usually accompanied by a base-line measurement of the characteristic. For example, in FIG. 1 system 100 may monitor and acquire the subject's eye movements using a VOG camera (106), as different stimulus images are displayed to the subject on a display panel (109).

Referring back to FIG. 2a, which discloses the enrollment process, a subject's responses, to a visual stimulus, which is generated (204) and displayed (205) to him, may be used as the bio images input (202) or the bio signals input (201) of the enrollment procedure. In some embodiment, using the versatility and complexity of eye movements, specific scenes/pictures (still or video picture) and tasks are used to evoke typical eye movement responses from the subject. The responses allow the system to identify, authenticate or detect a subject state of mind (referred to in general as subject recognition in this application). Nystagmus eye movements may be evoked by a stimulus in the form of a moving repetitive pattern. Pursuit motion, on the other hand, may be induced only by displaying a moving object. Fixation and Saccades are usually best stimulated by a relatively static image. Displaying a dynamic image that includes a moving object may stimulate other responses, providing parameters such as velocity of eye movements, detection time, during which time a subject detects a target, and duration of fixations. These responses are believed to correspond to the rate of mental activity of the subject, as suggested in “Attention and Effort, Prentice-Hall, Inc., Englewood Cliffs, N.J., 1973, p. 65”, by Kahneman.

In some embodiments, the visual stimulus may be a target that moves on a screen in a predetermined pattern, and the subject may be asked to track, or follow, the target with his eye(s). The target's route-pattern may be a function of, or result from, different types of movements, which may include, at times, relatively smooth, continuous, movements, and at other times other types of movements. The smooth motions may include abrupt changes in the target's route. The abrupt changes may include changes in the direction and velocity of the moving target. Thus the subject's eyes maybe forced to respond to the stimulus by using corrective saccades. Accordingly, the subject's eye(s) movements will include a combination of saccadic movements in different directions, having different amplitudes and smooth pursuit movements. Since the target's route, may consist of a variety of movement types that can be pre-selected to form different movement sequences, a database such as database 203 may contain substantially an infinite number of unique target routes, i.e. a infinite number of stimuli. Thus the subject is encountered with an unpredictable stimuli (moving target), and an unpredictable task, each time he uses the system. The infinite stimuli may be divided into stimuli sets, in a way that any stimuli set selected, would provide adequate recognition. The stimuli database may be updated periodically to further improve the system's performance.

In some embodiments of the present disclosure, text may be part of, the visual stimulus presented to the subject.

The strong connection between an emotional state of an observer and his eye movement patterns may provide the system with additional, powerful, parameters, which may be used for subject recognition (identification, authentication and observer's state of mind (tired, alert, and stressed)).

For example, personality aspects of a subject may be identified by analyzing his eye movement pattern as he looks at a complex image and performs a predetermined task. In a similar way, parameters reflecting the subject's personality can be acquired from a subject's scan-path pattern, as he scans a complex scene. Another example of a visual task that may be used in this manner is counting a certain item or searching for a specific item within an image. Another example of a visual task that may be used is tracking a target on the display using a computer mouse. This type of task involves eye movement patterns as well as eye-hand coordination. Thus, as it can be seen, various visual stimuli can be used to evoke various responses from a subject, which will result in a subject's recognition.

Other parameters such as body temperature, skin impedance, heart rate, and breathing patterns are widely in use in different applications, many of them are medical applications. Unlike fingerprints and iris scan (which may be regarded as ‘stimulus-insensitive parameters’), parameters such as temperature, skin impedance, heart rate, breathing patterns and the like, change in response to a stimulus and, therefore they may be regarded as ‘stimulus-sensitive parameters’. Therefore, by acquiring stimulus-sensitive parameters from a subject before and after a stimulus is applied, the characterization of a subject may be further enhanced. For example, system 100 (FIG. 1) may acquire a subject's heart rate before and after a certain stimulus is applied, and compare the results. These parameters are referred to as Bio-Signal inputs 201 in FIG. 2a. The comparison result may support, or strengthen, a preliminary conclusion regarding the identity of the subject or his mental state, or it may negate the preliminary conclusion. The preliminary conclusion may be reached based on other, stimuli-sensitive or stimuli-insensitive parameters.

In addition to the dynamic biometrics characteristics, as detailed hereinbefore, other parameters may be acquired from a subject to further establish his identity. In the second stage of the enrollment, physical and physiological (static/permanent) biometrics characteristics of the subject are acquired (201, 202 of FIG. 2a). Examples of such biometric characteristics include (the list not being exhaustive) iris scan, fingerprints, hand shape, skin color and texture, and face image.

After acquiring the biometric data a smart set of features (parameters) needs to be formed from it—this is stage three of the enrollment process. This is done by calculating, selecting and combining several biometric parameters. By increasing the number of features used at this stage, the system's performance (security, robustness) will improve. However, more features means a longer processing time by system. For each specific application, the balance, or trade-off, between these two factors (performance enhancement versus processing time) may be set by the system's operator to optimally meet his needs/requirements. The process of forming a “smart” set of parameters may be done by employing feature extraction and classifying algorithms (206, 207 of FIG. 2a) on the acquired data. Examples of features, which can be extracted from the input data (201, 202), may include (the list not being exhaustive): saccades, frequency spectrum, eye movement velocities, eye movement acceleration rates and iris spot pattern.

In some embodiments Fuzzy Logic and Neural Networks may be used for this purpose. When using these types of algorithms, the first step is to conduct a training cycle, which enables the system to converge optimally for a specific set of data and a set goal. In this case this means the system has to “train” on all (or part) enrolled subjects, while its set goal is distinguishing between all the members in the training group (enrolled subjects). The output of such a training cycle is an optimization set of weights, which can be used for subject recognition, during the identification stage. This process is usually done once, but can be repeated occasionally, if necessary.

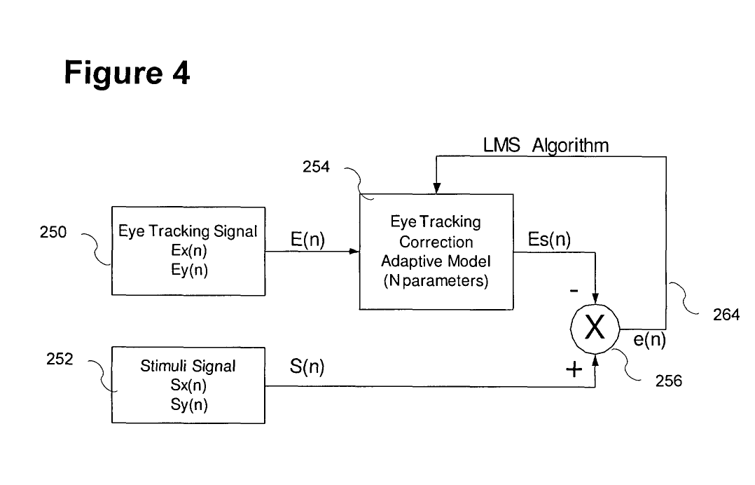

In other embodiments, an “Eye Tracking Identification Modeling” process may be used to form the “smart” set of identifying parameters. The human eye tracking mechanism is based on continuous feedback control, which is used to correct the eye's position in real-time. Therefore by using system modeling, the characteristics and quality of the subject's eye tracking mechanism may be quantified. FIG. 4, presents an example of how a set of N parameters can be extracted from a subject's eye movements as he responds to a specific visual stimulus—moving target. These parameters may be used as part of the subject's identification parameters. More specifically, the digital representation of a subject's eye movement signals {Ex(n), Ey(n) or E(n) (250), enters an Adaptive Correction Model procedure (254). The adaptive model represents the input E(n) as Es(n), using N parameters. The adaptive model iteratively changes the N parameters, to minimize the error e(n) (264), which is calculated as the difference (256) between the eye tracking modeled signal (after correction) Es(n) and the stimulus signal S(n) (252). The error may be minimized, for example, by using the LMS algorithm.

The process of forming a “smart” set of parameters, as described hereinbefore, results in the formation of a subject's identification profile, (208, FIG. 2). In some embodiments, the identification profile may include, in addition to the parameters, extracted from the bio inputs, information regarding the stimulus used to evoke the corresponding response. Furthermore, as illustrated in FIGS. 2a and 2b, the stimulus itself may be processed by the algorithm classifier (207) together with the input signals and images to form the identification profile. Accordingly, the Identification Profile, which consists of multiple variables, is referred to hereinafter as a subject's “Multi-Variant Identification” (MV-ID) profile. When the MV-ID profile is used as a reference, to an individual's biometric characteristics it may be referred to as a MV-ID template.

After the subject's MV-ID profile is formed, in the enrolment procedure, it may be encrypted and saved (209) in database 210 as an MV-ID template. The MV-ID database may be dynamically updated. The templates may be stored and used in one of two approaches. According to a first approach, MV-ID templates may be placed in a single central database or be distributed among several databases (“Dispersed System”) which hold the Identification Templates of all subjects enrolled to the system. The database may be either local or remote, in respect to system 100 of FIG. 1. U.S. Pat. No. 6,018,739, for example, refers to such an approach. According to a second approach, MV-ID Templates may be saved on a Smart Identification Card which the subject may carry with him U.S. Pat. No. 5,496,506, for example, refers to such an approach.

To summarize, FIG. 2a, schematically illustrates an exemplary enrollment process, according to some embodiments of the present disclosure. The inputs to the enrollment process are Bio-Signals and Bio-Images (201 and 202, respectively) of a subject, which were monitored and measured, as explained hereinbefore in system 100 of FIG. 1. These inputs may be physical biometrics (iris scan, finger print, for example), or dynamic physiological and behavioral biometrics (heart rate, impedance, temperature, pupil size, blinking, eye movement, for example). Next, a set of stimulus from a database (203) is sent to the display (205) via a display generator (204). The subject's responses to the stimuli may be monitored, measured and provided as additional Bio-Signal (201, 202) and Bio-Image (202) inputs. The latter process is repeated for every subject that needs to be enrolled into the system. All input-data acquired is fed to a Feature Extractor (206) and an Algorithm Classifier (207), which prepares the MV-ID profiles (208) for each subject). The MV-ID may then be encrypted and saved (209) to Templates database (210), which may updated.

### The Identification Process

After the system has completed the enrollment stage, it is now ready to be used to recognize subjects, which were enrolled into the system. The system is able to identify, or authenticate a subject, as well as to identify his psychological status (state of mind) FIG. 2b schematically illustrates an exemplary recognition process, according to some embodiments of the present invention. When a subject approaches the system, and needs to be recognized, a set of visual stimulus is selected from a data base unit (203), and displayed on a display unit (205), via a display generator (204). The subject does not know what stimuli he is going to see. Stimulus/stimuli, according to some embodiments, may be referred to as “smart stimulus/stimuli” and may refer to stimulus/stimuli, which may be selected from a database, which contains a large number of visual stimuli, in a way that would enable recognition. Thus many different combinations, stimuli sets, may be used. Thus the subject is surprised, and unprepared for what he is about to see. The fact that the stimulus are selected from a large database, combined with the fact that the evoked responses include voluntary and involuntary elements, which cannot be controlled by the subject, implies that the system is very difficult to fool, and that the operator has control on the security level required. Accordingly, one or more stimuli combinations may be selected, per subject, to meet particular needs. For example, allowing a subject entrance to his office may necessitate use of one set of stimuli whereas allowing a person entrance to a highly restricted area may necessitate use of a different set of stimuli.

One unique feature of the presented system and method is that it may detect if a subject is being forced to access the system. When a subject is trying to get recognition unwillingly, the stress he is under would alter his responses, thus the system will detect a problem, and will not grant him access.

Referring back to FIG. 2b, which demonstrates some embodiment of a recognition process, a subject's responses to a set of stimuli, together with additional Bio signals and Bio images (201, 202), which were acquired by a system such as 100 of FIG. 1, may be used as inputs to the recognition process. The inputs (acquired data), as described hereinbefore, may include Physical Biometrics parameters (iris scan, finger print, for example), or Dynamic Physiological & Behavioral Biometrics parameters (heart rate, impedance, temperature, pupil size, blinking, and eye movement, for example). Details on the acquisition process can be found in the previous section, which disclosed the enrolment process. The inputs (201, 202) may be processed by feature extraction unit (206), before they enter a classifier module (207) with their corresponding stimulus. The classifier module is responsible for forming the Multi-Variant Identification profile (208). The nature of these classifying algorithms was already disclosed hereinbefore, in the paragraph describing the enrolment procedure. In some embodiments, if classification was implemented, during enrollment, by a Neural-Net Classifier, the pre-calculated weights, calculated during training in the enrollment process, are used for the recognition process. The weights are applied to a subject's acquired data (Bio-Signals & Bio-Images) to form his Multi-Variant Identification (MV-ID) profile. Following the formation of a subject's MV-ID profile, a Search & Match Engine (229) is used to find a matching MV-ID template in the MV-ID Template Data-Base (210).

In the search process the MV-ID profile is compared to MV-ID templates, which may be encrypted. The templates may typically be stored on a user's personal Smart Identification Card or in a central Data base, which can be local or remote. Many algorithms and products deal with this stage of searching & matching the identification profiles. The task is challenging, especially when there are many subjects enrolled to a central database unit. The disclosed system may use any of them. Examples of such methods are disclosed in US 20040133582. In general, to establish a match between the MV-ID profiles, many methods can be applied. It is important to understand that there is rarely a “perfect match” between the MV-ID profiles (enrolled vs. tested). This is true for features extracted from static signals (finger print for example), which may be corrupted by noise, and is especially true for dynamic features. Thus there may be a great significance on the recognition process in extracting a “good” MV-ID, and applying an efficient match engine. The system always seeks for the closest match it can find in the template database (210). An example of a method, which can be used for obtaining a match, is the “Minimum Multi Dimensional Distance” algorithm. In this algorithm the distance (for example Euclidian distance) between MV-ID profiles is calculated. If the calculated distance is less then a predefined threshold value, a match is obtained. Furthermore, the smaller the distance between the profiles, the higher the confidence of a correct match-correct recognition. The threshold may be a fixed threshold value or a user defined one. If a match is not established (231), the system continues to display visual stimulus to the subject, and additional Bio-Signals and Bio-Images are acquired and processed as described above. This process continues until the desired threshold is reached, or a maximum number of iteration is exceeded. Once this process is finished, the system is ready to give its output, which would usually be a positive or negative identification of the subject (233). The number of enrolled subjects has a direct influence on the system's characteristics and performance. The greater the number of enrolled subject's, the more features are needed to establish the identification. The number of subject's also has a significant influence on the system's processing time (search and match).

### The System

### The Display

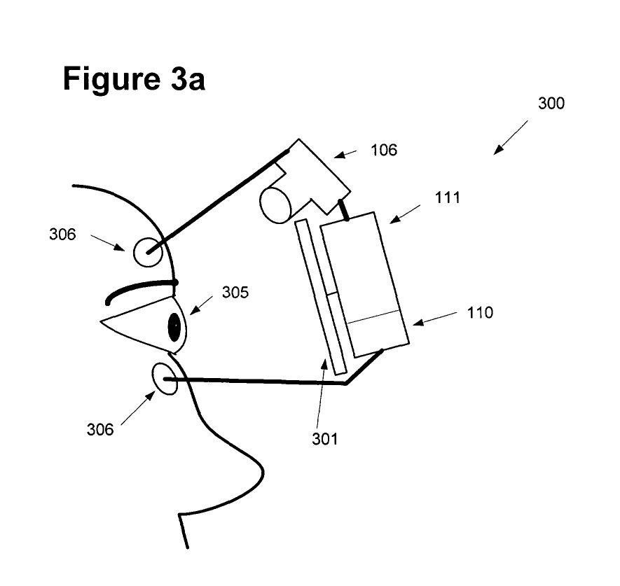

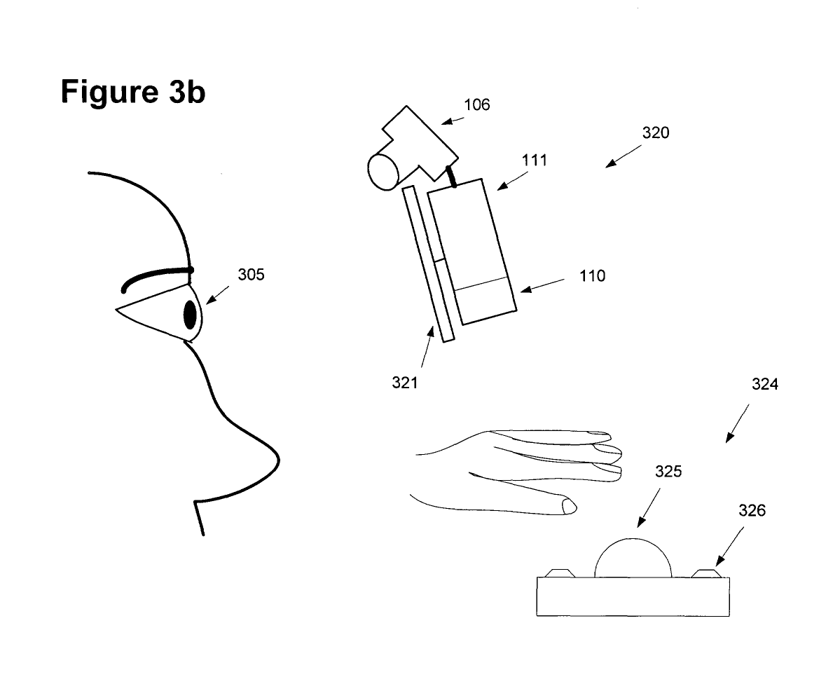

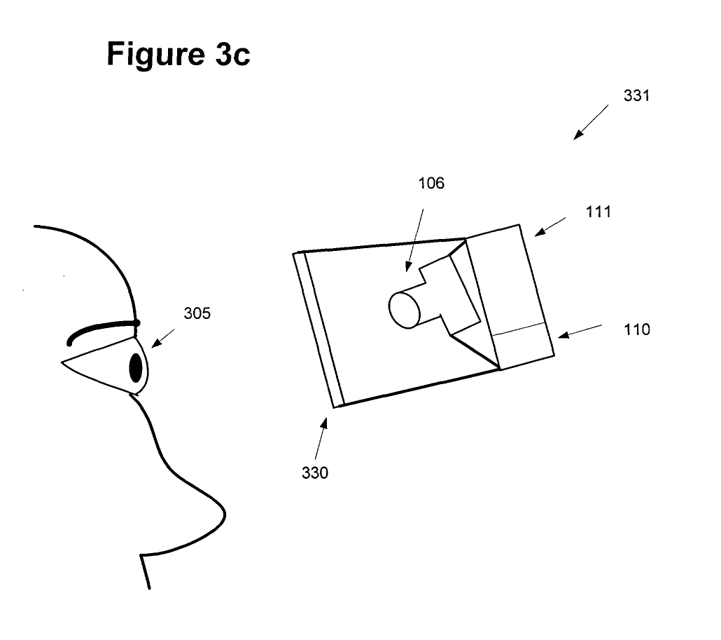

Some embodiments of the disclosed system require the use of visual stimuli to obtain dynamic biometric characteristics associated with the subject. The visual stimuli may be presented to the subject on a display unit (109), as illustrated in system 100 of FIG. 1. The nature of the visual stimuli was detailed hereinbefore, and it may be displayed in black-and-white, grayscale or color. A controller (such as processor 111) may manage the displayed images. In some embodiments (FIG. 3a) of the recognition system 100, a relatively small liquid crystal display (“LCD”) screen 301 may be used as part of a head mount apparatus 300. For example, LCD screen 301 may be as small as 2″-4″, with a minimum resolution of 100 dots per inch (“dpi”). In other embodiments, a standard LCD or a cathode-ray tube (“CRT”) may be used for displaying stimuli, as schematically illustrates in FIG. 3b (321). According to yet another embodiment, a semi-transparent LCD display unit (330, FIG. 3c) may be used, thus enabling an imaging device (334) to be positioned behind the display unit (330). It is noted that essentially any type of display apparatus or method, known today, or to be devised in the future, is applicable to embodiments of the present invention.

### Control Unit

A controller (111) or a microprocessor may be used in the system for various tasks. The controller may manage the selection, generation and display of the stimuli, presented to the subject. The control may be responsible for the operation and synchronization of a variety of transducers and sensors such as sensors 101 to 105 and cameras such as 106 and 107 of FIG. 1. In addition it may be used for managing data acquisition, processing and analysis. The controller may also manage and synchronize all additional operations, components and ongoing processes in the system such as database formation, updating and searching.

### Sensors

As explained hereinbefore, a variety of sensors may be utilized to enable the acquiring of a broad set of characteristic parameters. It is noted that sensors for acquiring temperature, impedance, fingerprints, heart rate, iris image and breathing patterns, are well known to those skilled in the art, and are readily available. For example, skin impedance can be measured using the galvanic skin response sensor of Thought Technology Ltd. W. Chazy, N.Y. USA. his scanners are also commercially available The IrisAccess 3000, from LG electronics and the OKI IrisPass-h from Iridian technologies are examples of such systems.

### Eye Tracking Sensors

Several technologies may be used for measuring and acquiring different types of eye movement and eye movement patterns, such as fixation, scan path patterns, saccades, and the like. Technical solutions for eye-tracking have been reviewed by Schroeder, W. E., (“Head-mounted computer interface based on eye tracking”. Proceedings of the SPIE—The International Society for Optical Engineering, Vol: 2094/3, 1114-1124, 1993). Complete eye tracking systems are sold by companies like ASL (www.a-s-1.com) and SMI (www.smi.de), for example. Most available eye tracking systems are based on one of three technologies: video cameras (VOC), which are used as VOG devices, photo-detector sensors, and Electro-Ooculography (“EOG”) devices. However, it should be noted that eye tracking can be implemented by other technologies, known today, or to be devised in the future.

A video camera (“VOC”) is one of the more popular sensors used for measuring different eye movements. A standard VOC may be used, for example, by system 100 of FIG. 1. Since VOCs are sensitive to light in the visible and in the near-infra-red (“NIR”) range, a subject may be illumination by NIR light, thereby improving the image without dazzling the subject. A standard VOC with an image rate of about 15-30 frames per second (“fps”) with a resolution between 1 and 2 mega pixels should be sufficient for many eye-tracking tasks. However, a standard VOC may not be enough in cases where fast saccades need to be monitored and acquired. Saccades include fast eye movements of about 40 Hz and, therefore, the frame rate of a standard VOC, which is typically 15 fps, is inadequate to acquire them. Therefore, in cases where saccades need to be acquired, a more advanced video camera, which provides a video rate of at least 80 fps, and a standard resolution of 1 to 2 Mega pixels, would be more appropriate. Video-based eye-tracking systems can be either self-developed, or purchase “of the Shelf”. For example, an eye tracking system based on video capability can be purchased from Visual Interaction, a recent spin-off of SMI (www.smi.de). “Visual Interaction” provides an eye tracking system that connects to the host computer via a universal serial bus (“USB”) and includes displays and cameras. “Blue Eyes” camera system, which has been developed by International Business Machines (IBM), Armonk, N.Y., U.S.A., also provides eye gaze tracking solution. The “Blue Eyes” solution was originally proposed for use in monitoring consumer reactions to a scene. Another example for an eye tracking system can be found in “Oculomotor Behavior and Perceptual Strategies in Complex Tasks” (published in Vision Research, Vol. 41, pp. 3587-3596, 2001, by Pelz 2001). In this paper, Pelz discloses an eye gaze tracking system that was used to examine eye fixations of people. Other examples of eye gaze monitoring technologies can be found, in U.S. Pat. No. 5,765,045, for example.

An alternative technique for measuring eye movements is based on Electrooculargraphy (EOG) measuring technologies. An advantage of such a technique is that the frames-per-second limitation does not apply to it, as opposed to standard VOC-based systems. In general, an EOG signal is generated within the eyeball by the metabolically active retina. The signal changes approximately 6 to 10 mVolts relative to a resting potential (known as the “corneal-retinal potential”). The potential generated by the retina varies proportionally with eye angular displacement over a range of approximately thirty degrees. Therefore, by measuring EOG signals, the horizontal and vertical movements of an eye can be tracked with an angular resolution of less than one degree. A subject's EOG signals may be measured using a set of electrodes (silver chloride electrodes or any other suitable noninvasive skin electrodes). The electrodes are typically characterized as having an area of about 0.25 cm² each, and are located around the eyes and in contact with the skin.

Another technique for measuring eye movements is based on measuring reflected light from the eye using a light source (or several) and a photo detector (or several).

In some embodiments, when information from both eyes is required, the system (100, of FIG. 1) may use two independent sensing and acquisition devices or channels. An example feature, which requires eye movement acquisition from both eyes simultaneously, is the Convergence motion of eyes.

### Examples of Possible Set-Ups

The disclosed system and method can be set up in a variety of ways, as schematically shown in FIGS. 3a, 3b and 3c.

In some set-ups (FIG. 3a) various sensors as well as a display are coupled together and attached to the eye area, providing a compact system. In this set-up the entire apparatus (300) is located around the subject's eye (305). The apparatus is in a form of a head mount. The subject is stimulated by a set of visual images, which are presented to him on a display panel (301). The stimulus evokes a set of reactions from the subject. The reactions are acquired by a VOG camera (106), and contact sensors (306). THE VOG camera can be for example a charge-coupled device (“CCD”) camera, a complementary metal-oxide-semiconductor (“CMOS”) camera or a photo detector. The contact sensors (306) provide output signals that are associated with parameters such as impedance, temperature and pulse (the list not being exhaustive). The acquired data is amplified and digitized (110), and then processed and analyzed (111), to enable verification or identification of the subject.

In another set-up (FIG. 3b), the system is divided in to two parts (320, 324). One part of the apparatus (320), which includes a VOG camera (106), a display unit (321), amplifiers and an A/D units (110) and a controller (111), is located at some distance from the subject (no contact), thus providing a contact-less device. A second part (324), which is designed as track ball mouse, may include several features. The first feature includes a track ball (325), which maybe used by the subject, when asked to perform a combined motoric-visual task, or it may be used to enter data in to the system. An example of such a task could be, tracking a moving target using the mouse, or counting and entering the number of people in an image displayed as a stimulus to the subject. The track ball can include additional sensors, which may acquire parameters such as (but not limited to): heart-rate, temperature, impendence, or even a finger print. The track ball can also include stimulating devices such as, but not limited to mechanical vibration, heating, etc. Additional contact sensors (326) are located in proximity to the track ball (325). These sensors may acquire parameters such as but not limited to): impedance, temperature, ECG, and heart-pulse.

In another set-up (FIG. 3c), the apparatus (331), which includes a VOG camera (106), a display unit (330), amplifiers (332), and A/D units (110), and a controller (111) is positioned at some distance in front of the subject. In this set-up, VOG camera (106) is located behind the display screen (330), which is semi-transparent, such that semi-transparent screen 330 is positioned between the subject's eyes 305 and VOG camera 106.

The detailed embodiments are merely examples of the disclosed system and method. This does not imply any limitation on the scope of the disclosure. Applicant acknowledges that many other embodiments are possible.

1-43. (canceled)

44. A system for recognizing a subject, the system comprising:
a device adapted to present at least one visual stimulus to the subject, said at least one visual stimulus comprising at least one member of the group consisting of a static image, a dynamic image, a static pattern, a dynamic pattern, a moving target or any combination thereof;
at least one sensor adapted to acquire at least one response of the subject evoked as a direct consequence of said at least one visual stimulus, wherein said response comprises at least one response selected from the group consisting of eye movement, pupil size, pupil dynamics and any combinations thereof; and
a controller adapted to determine a multi-variant identification (MV-ID) profile corresponding to said subject based on analysis of both of said at least one visual stimulus and said at least one response, and adapted to compare the MV-ID profile resulting from said analysis to one or more pre-stored subject-specific identification templates for recognizing said subject.

45. The system of claim 44 wherein said visual stimulus evokes a response comprising an involuntary response element from the subject.

46. The system of claim 44, wherein recognizing a subject comprises:
performing at least one operation selected from the group consisting of establishing the identity of said subject, authenticating the identity of said subject, determining psychological aspects of said subject and any combinations thereof.

47. The system of claim 46, wherein said psychological aspect of said subject comprises at least on aspect selected from the group consisting of state of mind, level of stress, anxiety, attentiveness, alertness, honesty and any combinations thereof.

48. The system of claim 44, wherein said visual stimulus comprises at least one unpredicted stimulus.

49. The system of claim 44, wherein said controller is further configured to dynamically update one or more of said subject-specific identification templates.

50. The system of claim 44, wherein said controller considers a time dependent behavior of said at least one response before during and after said visual stimulus is generated.

51. The system of claim 44, wherein said at least one sensor is further configured to acquire a response based on a physical, physiological or behavioral characteristic parameter from the subject.

52. The system of claim 51, wherein said characteristic parameters comprise at least one parameter selected from the group consisting of heart rate, body temperature, iris scan, blinking, finger print, impedance, eye movement, skin texture, breathing pattern and any combinations thereof.

53. The system of claim 44, wherein said eye movements comprise at least one movement selected from the group consisting of a fixation, gaze, saccades, convergence, rolling, pursuit, nystagmus, drift and microsaccades, physiological nystagmus and any combinations thereof.

54. A method for automatically recognizing a subject, the method comprising:
presenting said subject with at least one visual stimulus, said at least one visual stimulus comprising at least one member of the group consisting of a static image, a dynamic image, a static pattern, a dynamic pattern, a moving target and any combination thereof;
acquiring, by at least one sensor device, at least one response of said subject to said at least one visual stimulus, wherein said response comprises at least one response selected from the group consisting of eye movement, pupil size, pupil dynamic or any combination thereof;
automatically determining, by a computing device, a multi-variant identification (MV-ID) profile corresponding to said subject based on analysis of both of said at least one visual stimulus and said at least one response, and
comparing the MV-ID profile resulting from the analysis to one or more pre-stored subject-specific identification templates for recognizing said subject.

55. The method of claim 54, wherein said visual stimulus evokes a response comprising an involuntary response element from the subject.

56. The method of claim 54, wherein recognizing a subject comprises performing at least one operation selected from the group consisting of establishing the identity of said subject, authenticating the identity of said subject, determining psychological aspects of said subject and any combinations thereof.

57. The method of claim 56, wherein said psychological aspects of said subject comprise at least one aspect selected from the group consisting of state of mind, level of stress, anxiety, attentiveness, alertness, honesty or any combination thereof.

58. The method of claim 54, wherein said visual stimulus comprises at least one unpredicted stimulus.

59. The method of claim 54, comprising dynamically updating the identification templates of said subjects.

60. The method of claim 54, wherein said determining includes analysis of a time dependent behavior of said at least one response before, during and after said stimulus is generated.

61. The method of claim 54, further comprising acquiring a physical, physiological or behavioral characteristic parameter from the subject.

62. The method of claim 61, wherein said characteristic parameters comprise heart rate, body temperature, iris scan, blinking, impedance, eye movement, finger print, skin texture, breathing pattern or any combination thereof.

63. The method of claim 54, wherein said eye movements comprise fixation, gaze, saccades, convergence, rolling, pursuit, nystagmus, drift and microsaccades, physiological nystagmus or any combination thereof.
